(19) United States
(12) Patent Application Publication
(10) Pub. No.: US 2026/0106894 A1
(43) Pub. Date: Apr. 16, 2026

(54) COLLECTING DEVICE, COLLECTING METHOD, AND COLLECTING PROGRAM

(71) Applicant: NTT, Inc., Tokyo (JP)

(72) Inventors: Hiroki NAKANO, Musashino-shi, Tokyo (JP); Daiki CHIBA, Musashino-shi, Tokyo (JP); Takashi KOIDE, Musashino-shi, Tokyo (JP); Naoki FUKUSHI, Musashino-shi, Tokyo (JP)

(73) Assignee: NTT, Inc., Tokyo (JP)

(21) Appl. No.: 19/114,022

(22) PCT Filed: Oct. 27, 2022
(86) PCT No.: PCT/JP2022/040259

§ 371 Date: Mar. 21, 2025

(51) Int. Cl. H04L 9/40; G06Q 10/40

(52) U.S. Cl. CPC H04L 63/1483; G06Q 10/40

(57) ABSTRACT

A collection device includes a memory and processing circuitry configured to collect postings related to a security threat from postings of a social networking service (SNS) using a security keyword that is a keyword related to the security threat, extract a co-occurrence keyword that is a keyword co-occurring beyond a predetermined frequency from the collected postings related to the security threat, and collect a posting including the co-occurrence keyword and an image associated with the posting from the postings of the SNS.

### TECHNICAL FIELD

The present invention relates to a collection device, a collection method, and a collection program for collecting postings related to security threat information.

### BACKGROUND ART

On social platforms, instances of suspicious phishing attacks observed by well-meaning general users themselves in addition to security experts are more often shared in images (for example, screen shots) or the like as attention warnings. If such information can be collected, analyzed, and extracted as early and accurately as possible, it is useful for countermeasures against phishing attacks.

Security blogs, security reports, social platforms and the like are available as targets for extracting security threat information such as phishing attacks.

For example, natural language processing techniques are applied to blogs or reports in which threat information analyzed by security experts is collected as in NPLs 3 and 4 and are extracted as formatted data, and thus mechanical utilization can be achieved.

In NPL 5, Twitter (registered trademark), Facebook (registered trademark), news sites, security blogs, security forums, and the like are compared and evaluated as collection targets of threat information, and it has been reported that Twitter is the best in both an amount and quality of information that can be collected.

NPLs 6, 7, and 8 propose techniques for extracting URLs, domain names, hash values, IP addresses, vulnerability information, and the like related to threats from Tweets of users by focusing on specific users or keywords of Twitter. According to the techniques, it has been reported that a large number of useful threat information can be obtained.

### CITATION LIST

### Non Patent Literature

[NPL 1] Vigorously continuing phishing attack-unique URLs, about 270 daily average, Security NEXT, [online], [retrieved on Oct. 13, 2022], Internet <URL:https://www.security-next.com/134607>
[NPL 2] 2022/02 phishing report status, [online], Council of Anti-Phishing Japan, [retrieved on Oct. 13, 2022], Internet <URL:https://www.antiphishing.jp/report/monthly/202202.html>
[NPL 3] Zhu, Ziyun and Dumitras, Tudor, “ChainSmith: Automatically Learning the Semantics of Malicious Campaigns by Mining Threat Intelligence Reports”, 2018 IEEE European Symposium on Security and Privacy
[NPL 4] Satvat, Kiavash and Gjomemo, Rigel and Venkatakrishnan, V. N., “EXTRACTOR: Extracting Attack Behavior from Threat Reports”, IEEE EuroS&P 2021.
[NPL 5] Shin, Hyejin and Shim, WooChul and Moon, Jiin and Seo, Jae Woo and Lee, Sol and Hwang, Yong Ho, “Cybersecurity Event Detection with New and Re-emerging Words,” ASIA CCS 2020.
[NPL 6] Alves, Fernando and Andongabo, Ambrose and Gashi, Ilir and Ferreira, Pedro M. and Bessani, Alysson, “Follow the Blue Bird: A Study on threat data published on Twitter”, ESORICS 2020.
[NPL 7] Shin, Hyejin and Shim, WooChul and Kim, Saebom and Lee, Sol and Kang, Yong Goo and Hwang, Yong Ho, “#Twiti: Social Listening for Threat Intelligence”, WWW 2021.
[NPL 8] Roy, Sayak Saha and Karanjit, Unique and Nilizadeh, Shirin, “Evaluating the Effectiveness of Phishing Reports on Twitter”, eCrime 2021.

### SUMMARY OF INVENTION

### Technical Problem

However, the foregoing techniques of the related art have the following problems.

(1) Tweets that are Information Collection Targets are Limited

In the techniques of the related art, since information collection targets are limited to specific user accounts, information regarding reports of phishing attacks by various users cannot be collected. In the techniques of the related art, limited keywords such as “#phishing” and “#attention warnings” are collection targets. Therefore, the keywords can be collected only in Tweets of a limited range.

### (2) Information Extraction Targets are Only Sentences in Fixed Formats Included in Tweets

Although reports of phishing attacks by Tweets include images such as screen shots, the techniques of the related art target only sentences in a Tweet as information extraction targets. Therefore, information included in images cannot be extracted by the techniques of the related art. Further, since users post information in various forms, only limited information can be extracted by the techniques of the related art specialized in fixed forms.

As a result, the techniques of the related art have a problem that security threat information cannot be widely extracted. Accordingly, an object of the present invention is to solve the above-described problem and to widely extract security threat information.

### Solution to Problem

In order to solve the foregoing problem, according to an aspect of the present invention, a collection device includes: a first collection unit configured to collect postings related to a security threat from postings of a social networking service (SNS) using a security keyword that is a keyword related to the security threat; a keyword extraction unit configured to extract a co-occurrence keyword that is a keyword co-occurring beyond a predetermined frequency from the collected postings related to the security threat; and a second collection unit configured to collect a posting including the co-occurrence keyword and an image associated with the posting from the postings of the SNS.

### Advantageous Effects of Invention

According to the present invention, security threat information can be widely extracted.

### BRIEF DESCRIPTION OF DRAWINGS

FIG. 1 is a diagram illustrating a configuration example of a system.

FIG. 2A is a diagram illustrating a configuration example of a collection device.

FIG. 2B is a flowchart illustrating an example of a processing procedure performed by the collection device.

FIG. 3 is a diagram illustrating a specific example of the processing procedure performed by the collection device.

FIG. 4 is a diagram illustrating an example of a security keyword.

FIG. 5 is a diagram illustrating an example of generation of co-occurrence keywords.

FIG. 6 is a diagram illustrating an example of Tweets that are data collection targets.

FIG. 7 is a diagram illustrating processing for extracting a URL and a domain name from text and an image of a Tweet.

FIG. 8A is a diagram illustrating a configuration example of a classification device.

FIG. 8B is a flowchart illustrating an example of a processing procedure performed by the classification device.

FIG. 9 is a diagram illustrating a specific example of the processing procedure performed by the classification device.

FIG. 10 is a diagram illustrating examples of features generated from Tweets.

FIG. 11 is a diagram illustrating an example of account features of Tweets.

FIG. 12 is a diagram illustrating an example of content features of Tweets.

FIG. 13 is a diagram illustrating an example of URL features of Tweets.

FIG. 14 is a diagram illustrating an example of OCR features of Tweets.

FIG. 15 is a diagram illustrating an example of visual features of Tweets.

FIG. 16 is a diagram illustrating an example of context features of Tweets.

FIG. 17 is a diagram illustrating examples of features selected by a selection unit of FIG. 8A.

FIG. 18 is a diagram illustrating an evaluation result of classification accuracy of the system.

FIG. 19 is a diagram illustrating a report of phishing attacks extracted for a predetermined period by the system and the number of URLs related to the phishing attacks.

FIG. 20 is a diagram illustrating a comparison result between the system and OpenPhish.

FIG. 21 is a diagram illustrating a comparison result between the system and PhishTank.

FIG. 22 is a diagram illustrating an investigation result of the number of reports and the number of phishing URLs of users.

FIG. 23 is a diagram illustrating an effect of dynamically selecting a keyword.

FIG. 24 is a diagram illustrating a computer that executes a program.

### DESCRIPTION OF EMBODIMENTS

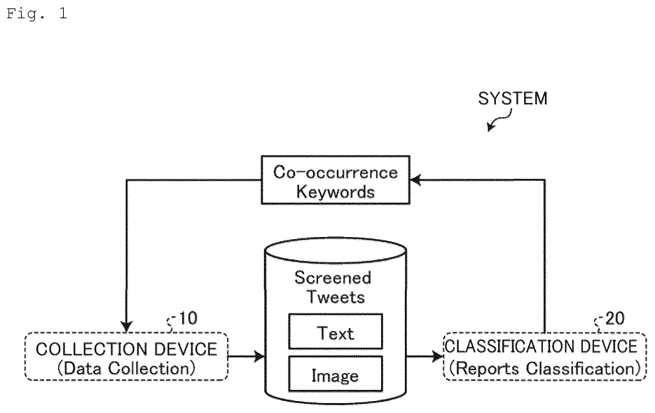

Hereinafter, modes for carrying out the present invention (embodiments) will be described with reference to the drawings. The present invention is not limited to the embodiment.

[Overview] First, an overview of a system including a collection device and a classification device according to the embodiment will be described with reference to FIG. 1.

A case in which postings of a social networking service (SNS) handled by the system are postings of Twitter (Tweets) will be described as an example, but the present invention is not limited thereto. Postings of the SNS may be Japanese postings or English postings.

In the embodiment, a case in which a system collects postings related to reports of phishing attacks from postings of an SNS will be described as an example, but postings related to reports of security threats other than phishing attacks may be collected.

For example, the system extracts Tweets of reports of phishing attacks from Tweets of users early and highly accurately. For example, the system includes a collection device 10 and a classification device 20. The collection device 10 and the classification device 20 may be communicably connected to each other via a network such as the Internet or may be provided in the same device.

(1) The collection device 10 widely collects Tweets which are likely to be reports of phishing attacks. For example, the collection device 10 extracts keywords (co-occurrence keywords) co-occurring in the reports of the phishing attacks. The collection device 10 widely collects Tweets (screened Tweets in FIG. 1) that are likely to be reports of phishing attacks using keywords (security keywords) related to security threats and the co-occurrence keywords.

(2) The classification device 20 classifies Tweets of reports of phishing attacks from Tweets collected by the collection device 10. For example, the classification device 20 extracts features of text and images of Tweets of reports of phishing attacks by machine learning and classifies whether each Tweet is a Tweet of a report of a phishing attack or another Tweet by using the extracted feature.

After the classification device 20 classifies the Tweets, the collection device 10 may extract co-occurrence keywords from a Tweet group classified as Tweets of the reports of the phishing attacks. Then, the collection device 10 may collect Tweets which are likely to be reports of phishing attacks by using the extracted co-occurrence keywords. In this way, the system can dynamically expand/contract keywords for collecting Tweets that are likely to be reports of phishing attacks and collect Tweets to be collected at an appropriate timing.

According to such a system, Tweets of the reports of the phishing attacks can be collected not only from the security expert but also from well-meaning general users. Since the system collects Tweets with many keywords, the reports of the phishing attacks can be analyzed on a large scale.

The system can accurately extract reports of the phishing attacks from the Tweets collected on the large scale. Further, since the system extracts information regarding the phishing attacks from both the text and the images included in the Tweets, useful information which cannot be obtained only by analyzing the text of the Tweets can be extracted.

The system has the following effects on the countermeasures against phishing attacks.

(1) Threat information can be collected in a wide range beyond a limited monitoring target of the techniques of the related art, and threat information can be provided from a new viewpoint.

(2) In particular, threat information which can be utilized as a countermeasure against phishing attacks targeting Japanese people that has been insufficient so far can be quickly provided.

(3) Applying the data obtained by the system to a filtering rule of a communication service provider or the like leads to a reduction in the number of victims of phishing attacks or the like.

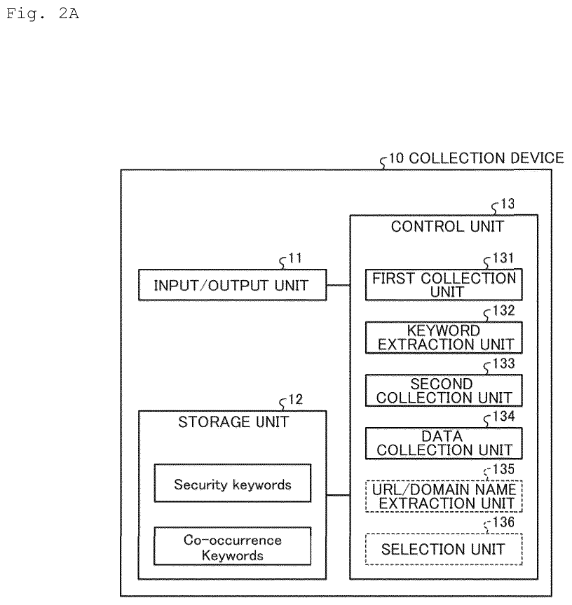

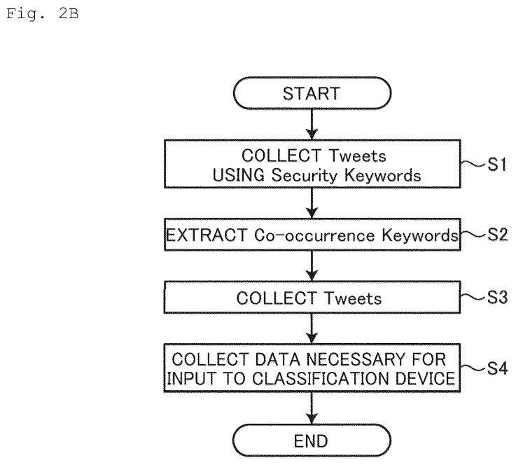

### [Collection Device]

[Configuration Example] Next, the collection device 10 will be described in detail. First, a configuration example of the collection device 10 will be described with reference to FIG. 2A. The collection device 10 includes, for example, an input/output unit 11, a storage unit 12, and a control unit 13.

The input/output unit 11 is an interface that performs inputting and outputting of various types of data. The input/output unit 11 receives, for example, an input of Tweets collected on Twitter. The input/output unit 11 outputs, for example, Tweets that are likely to be reported as phishing attacks extracted by the control unit 13 (screened Tweets in FIG. 1).

The storage unit 12 stores data, a program, and the like referred to when the control unit 13 executes various steps of processing. The storage unit 12 is realized with a semiconductor memory element such as a random access memory (RAM) or a flash memory, or a storage device such as a hard disk or an optical disc. The storage unit 12 stores, for example, security keywords, co-occurrence keywords, and the like extracted by the control unit 13.

The control unit 13 controls the entire collection device 10. A function of the control unit 13 is realized, for example, by a central processing unit (CPU) executing a program stored in the storage unit 12.

The control unit 13 includes a first collection unit 131, a keyword extraction unit 132, a second collection unit 133, and a data collection unit 134. There are cases in which a URL/domain name extraction unit 135 and a selection unit 136 are provided and causes in which they are not provided. The case in which the URL/domain name extraction unit 135 and the selection unit 136 are provided will be described below.

The first collection unit 131 collects Tweets of reports of phishing attacks from Tweets of users using security keywords that are keywords related to security threats.

The keyword extraction unit 132 extracts co-occurrence keywords which are keywords co-occurring beyond a predetermined frequency from Tweets of the reports of the phishing attacks collected by the first collection unit 131. The co-occurrence keywords may be extracted from Tweets classified as Tweets of the reports of the phishing attacks by the classification device 20.

The second collection unit 133 collects Tweets that are likely to be reports of phishing attacks from Tweets of the users using co-occurrence keywords. For example, the second collection unit 133 collects Tweets in which security keywords or the co-occurrence keywords are included in text of the Tweets or images associated with the Tweets from the Tweets of the users. The collected Tweets are stored in the storage unit 12.

The data collection unit 134 collects data necessary for an input to the classification device 20. For example, the data collection unit 134 collects the following data from the Tweets collected by the second collection unit 133. (1) A character string of a Tweet (for example, a hash tag, the number of characters, and the like), (2) meta information associated with a Tweet (for example, application information, presence or absence of defang, and the like), (3) information regarding an account of the Tweet (for example, the number of followers of the account, an account registration period, and the like), (4) an image included in the Tweet (for example, up to four images or the like associated with the Tweet). The collected data is stored in the storage unit 12.

[Example of Processing Procedure] Next, an example of a processing procedure executed by the collection device 10 will be described with reference to FIG. 2B. First, the first collection unit 131 of the collection device 10 collects Tweets of reports of phishing attacks using, for example, the security keywords (S1: collection of the Tweets using the security keywords). Then, the keyword extraction unit 132 extracts co-occurrence keywords which are keywords co-occurring beyond the predetermined frequency from the Tweets of the reports of the phishing attacks collected in S1 (S2: extraction of the co-occurrence keywords).

After S2, the second collection unit 133 collects Tweets which are likely to be reports of phishing attacks from the Tweets of the users using the security keywords and the co-occurrence keywords (S3). Thereafter, the data collection unit 134 collects data necessary for an input to the classification device 20 from the Tweets collected in S3 (S4).

The collection device 10 can execute the above processing to collect Tweets that are likely to be the reports of the phishing attacks.

The collection device 10 may include the URL/domain name extraction unit 135 and the selection unit 136 illustrated in FIG. 2A.

The URL/domain name extraction unit 135 extracts a URL and a domain name from the text and the image of the Tweet collected by the second collection unit 133. The selection unit 136 selects a Tweet which is highly likely to be a report of a phishing attack from the Tweets collected by the second collection unit 133 based on the URL or the domain name extracted by the URL/domain name extraction unit 135.

For example, when the URL or the domain included in the Tweet collected by the second collection unit 133 is not included in a list of URLs or domain names of legitimate websites, the selection unit 136 selects the Tweets as the Tweets that are highly likely to be reports of phishing attacks. The selection unit 136 selects Tweets which are highly likely to be reports of phishing attacks when a usage period of a domain name of a URL included in the Tweet is less than a predetermined period. For example, the selection unit 136 selects domain names of which the number of days that have elapsed since registration in WHOIS is less than a predetermined number of days as the Tweets which are highly likely to be reports of phishing attacks.

Thereafter, the data collection unit 134 collects data (for example, a character string of a Tweet) necessary for an input to the classification device 20 from the Tweets selected by the selection unit 136.

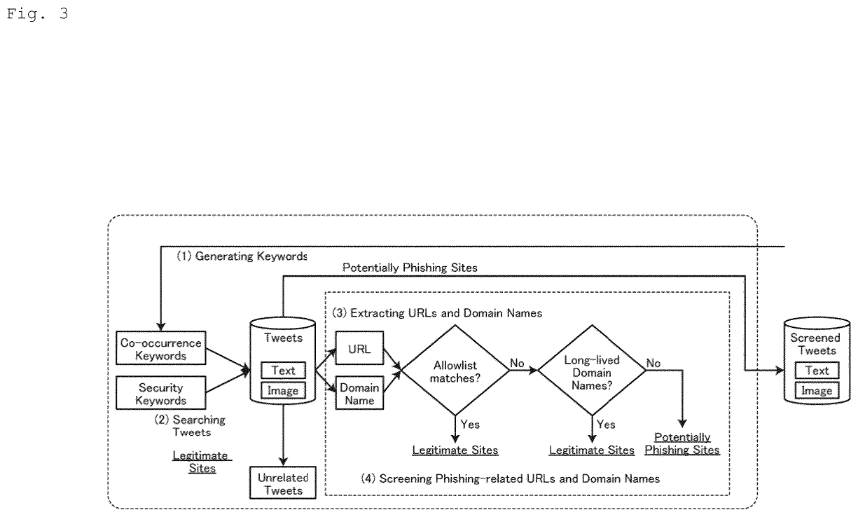

In this way, the collection device 10 can collect Tweets and data of the Tweets which are more likely to be reports of phishing attacks from the collected Tweets.

[Specific Example of Processing Procedure] Next, an example of a processing procedure executed by the collection device 10 will be described with reference to FIG. 3. A case in which the collection device 10 includes the URL/domain name extraction unit 135 and the selection unit 136 will be described as an example.

### (1) Generating Keywords

The collection device 10 generates two types of keywords (security keywords and co-occurrence keywords) for retrieving Tweets including the reports of the phishing attacks.

### (1-1) Security Keywords

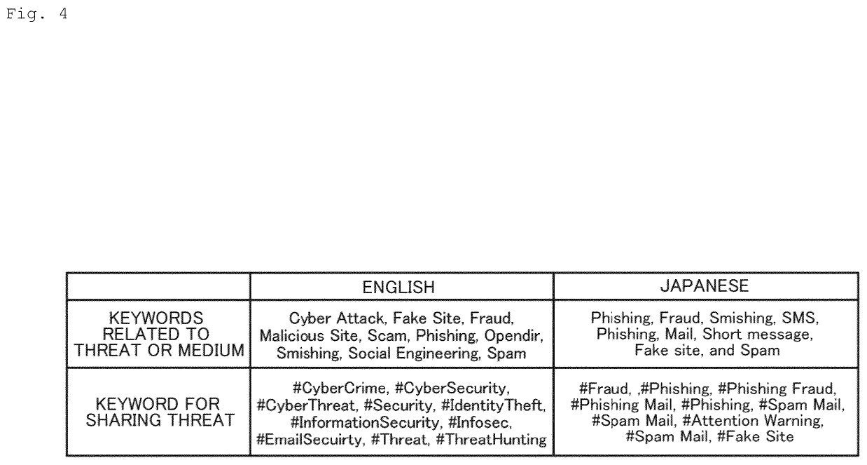

First, the security keywords will be described. For example, the collection device 10 generates, as a security keyword, a keyword related to a security threat such as “SMS” or “fake site” and a medium to which the security threat spreads, and a keyword for sharing security threat information such as “#phishing” or “#fraud” (see FIG. 4). The security keywords may use an existing keywords related to the security threat.

### (1-2) Security Keyword

Next, the co-occurrence keywords will be described. For example, the collection device 10 extracts a keyword (co-occurrence keyword) co-occurring at a frequency beyond a predetermined value only in the report of the phishing attack collected using the security keyword as a key.

For example, the first collection unit 131 of the collection device 10 collects Tweets of reports of phishing attacks from the Tweets of the users by using the security keywords. Thereafter, the keyword extraction unit 132 extracts co-occurrence keywords from the collected Tweets. For example, for each predetermined period, the keyword extraction unit 132 newly extracts co-occurrence keywords from the Tweets collected for the predetermined period.

For example, the keyword extraction unit 132 extracts a proper noun from a character string of the Tweet for the predetermined period, and calculates pointwise mutual Information (PMI) according to the following Formula (1). In Formula (1), X and Y are proper nouns included in Tweet.

$$PMI ( X , Y ) = log ( P ( X , Y ) / P ( X ) P ( Y ) ) \qquad Formula ( 1 )$$

Next, the keyword extraction unit 132 calculates SoA according to Formula (2). In Formula (2), W is a proper noun included in a Tweet and L is a label (security threat information or the like).

$$SoA ( W , L ) = PMI ( W , L ) - PMI ( W , ¬ L ) \qquad Formula ( 2 )$$

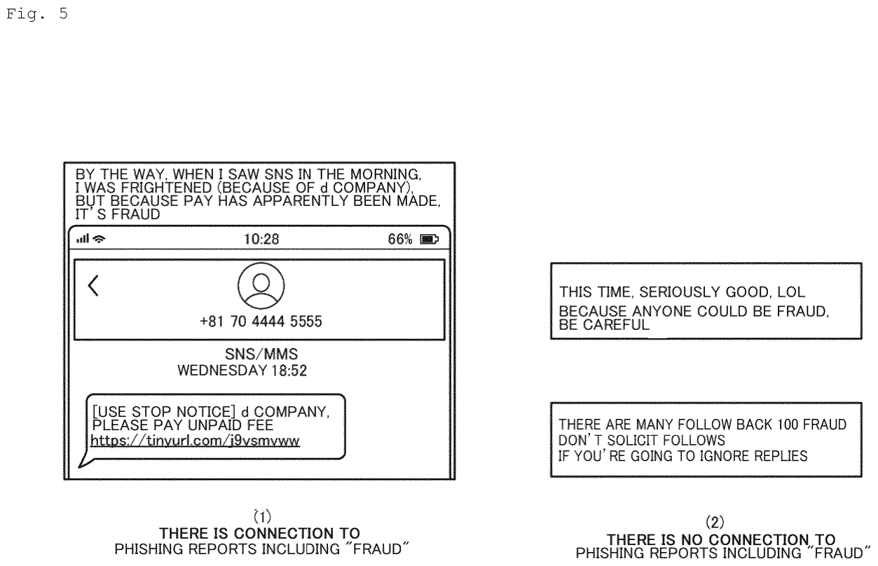

Then, the keyword extraction unit 132 extracts a proper noun in which SoA exceeds a predetermined threshold. For example, Tweets including a security keyword “fraud” includes a Tweet related to the phishing report illustrated in (1) of FIG. 5 and a Tweet unrelated to the phishing report illustrated in (2) of FIG. 5. The keyword extraction unit 132 extracts “d company” and “SMS” which are proper nouns (SoA exceeds a predetermined threshold) frequently appearing only in Tweet ((1)) related to the phishing report including “fraud” as co-occurrence keywords from the Tweets.

### (2) Searching Tweets

Next, the collection device 10 collects data necessary for an input to the classification device 20 from Twitter. For example, the second collection unit 133 collects Tweets that are likely to be reports of phishing attacks from the Tweet of the users using the co-occurrence keywords extracted by the keyword extraction unit 132. Accordingly, the second collection unit 133 can collect Tweets including URL/domains of potentially phishing sites, for example, as illustrated in FIG. 3.

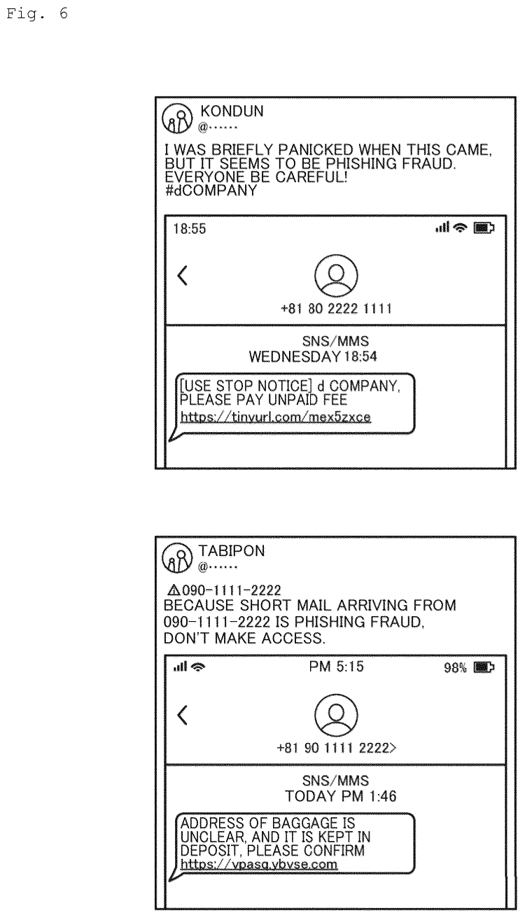

That is, the second collection unit 133 can collect the Tweets (screened Tweets) excluding the Tweets (unrelated Tweets) related to legitimate sites from the Tweets of the users. The data collection unit 134 collects the following data related to the Tweets (see FIG. 6) collected by the second collection unit 133.

A character string of a Tweet (for example, a hash tag, the number of characters or the like), meta information associated with the Tweet (for example, application information, presence or absence of defang, or the like), information regarding the account of the Tweet (for example, the number of followers, an account registration period, or the like), an image included in the Tweet (for example, up to four images or the like associated with the Tweet).

### (3) Extracting URLs and Domain Names

Next, the URL/domain name extraction unit 135 of the collection device 10 extracts URLs and domain names from the text and images of the Tweet (screened Tweets) collected by the second collection unit 133.

For example, the URL/domain name extraction unit 135 extracts a character string by applying optical character recognition to the image of the Tweet. The URL/domain name extraction unit 135 returns the character string of the Tweet to the original character string when there is a defang (for example, https->ttps). Then, the URL/domain name extraction unit 135 extracts a URL and a domain name through normal expression from the text and the character string of the image of the Tweet. Thereafter, the URL/domain name extraction unit 135 confirms whether the extracted domain name can exist using a public suffix list (see Literature 1) or the like.
Literature 1: “Public Suffix List”, https://publicsuffix.org/

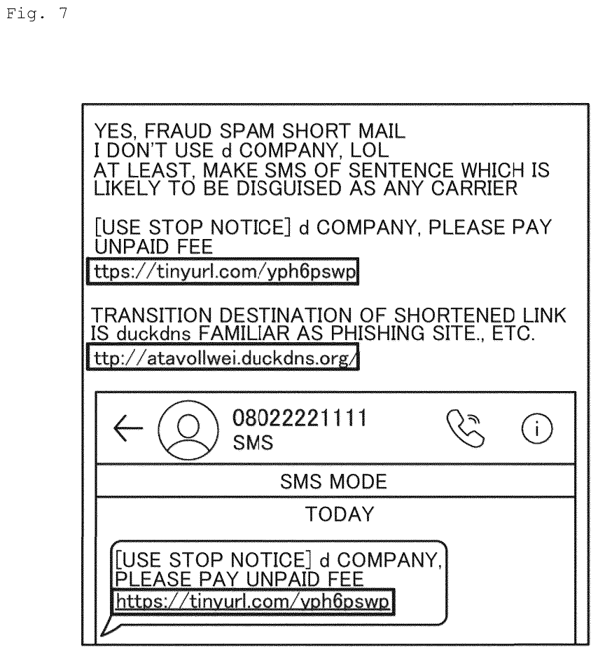

When it is confirmed that there is the extracted domain name, the URL/domain name extraction unit 135 extracts the domain name and the URL including the domain name. For example, the URL/domain name extraction unit 135 extracts the following URL and domain name from the Tweet illustrated in FIG. 7.
URL:https://tinyurl.com/yph6pswp, https://atavollwei.duckdns.org/
Domain name: tinyurl.com, atavollwei.duckdns.org

### (4) Screening Phishing-Related URLs and Domain Names

Next, the selection unit 136 screens the URLs and the domain names related to phishing from the URLs and the domain names extracted by the URL/domain name extraction unit 135.

For example, the selection unit 136 determines the extracted URLs and domain names as potentially phishing sites when the extracted URLs and domain names do not match Allowlist (for example, a list of URLs or domain names of legitimate websites) and are not long-lived domain names (for example, domain names of which the number of days elapsed from the registration of WHOIS is equal to or more than a predetermined number of days). The selection unit 136 selects Tweets including the URLs or the domain names determined to be the potentially phishing sites as Tweets that are highly likely to be reports of phishing attacks.

Conversely, when the extracted URLs and the domain names match Allowlist or are long-lived domain names, the selection unit 136 sets the URLs and the domain names are set as a legitimate sites.

For example, when the extracted domain names correspond to domain names of predefined URL shortening services, the selection unit 136 passes the domain names. When the extracted domain names match Tranco List (see Literature 2), the selection unit 136 excludes the domain names as domain names unrelated to the phishing attacks.
Literature 2: “A research-oriented top sites ranking hardened against manipulation-Tranco”, https://tranco-list.eu/

The selection unit 136 inquires of WHOIS about the extracted domain names. When the information cannot be acquired, the domain names are passed. Further, when 365 days or more have elapsed after registration of the domain names, the selection unit 136 excludes the domain names based on WHOIS information. When 365 days has not elapsed after the registration, the selection unit 136 passes the domain names. Then, the selection unit 136 selects Tweets of which there is at least one type of URL or domain name passed in the foregoing processing as the Tweets that are highly likely to be the reports of the phishing attacks.

In this way, the collection device 10 can extract Tweets that are highly likely to be the reports of the phishing attacks from the Tweets of the users.

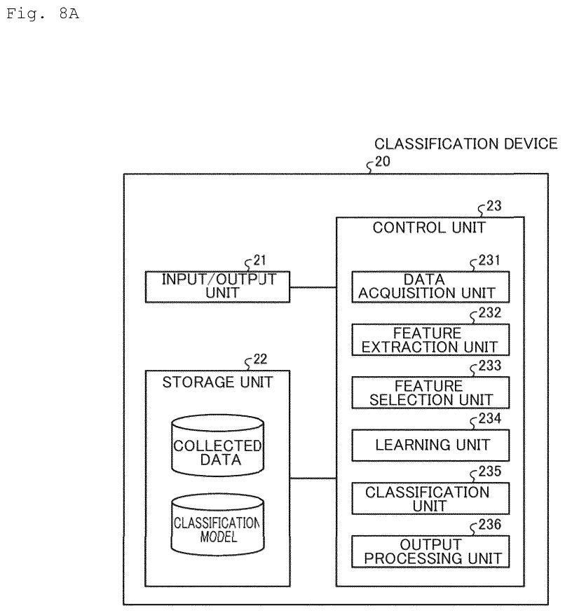

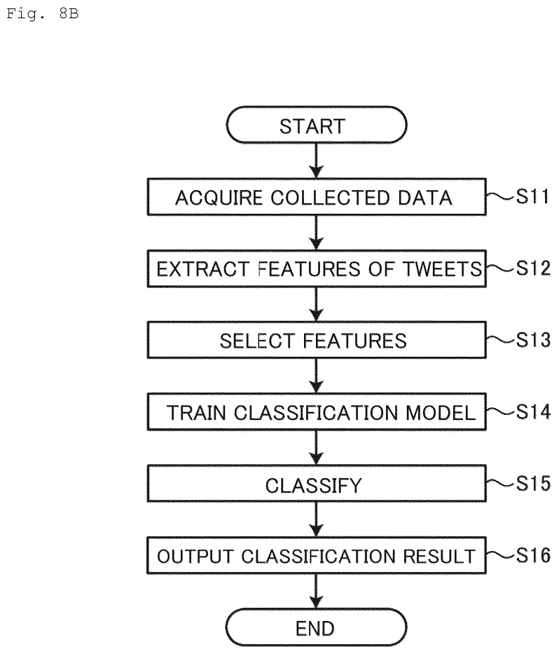

### [Classification Device]

[Configuration Example] Next, the classification device 20 will be described in detail. First, a configuration example of the classification device 20 will be described with reference to FIG. 8A. The classification device 20 includes, for example, an input/output unit 21, a storage unit 22, and a control unit 23.

The input/output unit 21 is an interface that performs inputting and outputting of various types of data. The input/output unit 21 receives, for example, an input of Tweets and data of the Tweets that are likely to be the reports of the phishing attacks collected by the collection device 10. The input/output unit 21 outputs a classification result of the control unit 23.

The storage unit 22 stores data, a program, and the like referred to when the control unit 23 executes various steps of processing. The storage unit 22 is realized with a semiconductor memory element such as a RAM or a flash memory, or a storage device such as a hard disk or an optical disc. For example, the storage unit 22 stores Tweets that are highly likely to be the reports of the phishing attacks received by the input/output unit 21 and data of the Tweets (collected data). The storage unit 22 stores parameters or the like of a classification model after learning for the classification model by the control unit 23.

The control unit 23 controls the entire classification device 20. A function of the control unit 23 is realized, for example, by CPU executes a program stored in the storage unit 22.

The control unit 23 includes, for example, a data acquisition unit 231, a feature extraction unit 232, a feature selection unit 233, a learning unit 234, a classification unit 235, and an output processing unit 236.

The data acquisition unit 231 acquires Tweets and the data of the Tweets that are highly likely to be the reports of the phishing attacks from the collection device 10.

The feature extraction unit 232 extracts features from Tweets and the data of the Tweets acquired by the data acquisition unit 231. For example, the feature extraction unit 232 extracts the features of the text and the images of the Tweets acquired by the data acquisition unit 231.

For example, the feature extraction unit 232 extracts, from the Tweets acquired by the data acquisition unit 231, features of the accounts of the Tweets, features of content of the Tweets, features of the URLs or the domain names included in the Tweets, features of character strings obtained through optical character recognition of images included in the postings, features of images included in the Tweets, features of contexts of the text included in the Tweets, and the like. The details of the extraction of the features of the Tweets by the feature extraction unit 232 will be described below by giving a specific example.

The feature selection unit 233 selects features effective for classification of whether the Tweets are Tweets related to reports of phishing attacks from the features extracted by the feature extraction unit 232. As a method of selecting the features, for example, Boruta-SHAP (see Literatures 3 and 4) is used.
Literature 3: Kursa, Miron B. and Rudnicki, Witold R., “Feature Selection with the Boruta Package,” Journal of Statistical Software 2010.
Literature 4: “BorutaShap: A wrapper feature selection method which combines the Boruta feature selection algorithm with Shapley values,” https://zenodo.org/badge/latestdoi/255354538

For example, the feature selection unit 233 selects a feature effective for classification of whether the Tweet is the Tweet related to the report of the phishing attack from the features extracted by the feature extraction unit 232 in the following procedure.

(1) The feature selection unit 233 first generates a fake feature including a random value in addition to a selection target feature.

(2) Subsequently, the feature selection unit 233 classifies the feature to be selected and the fake feature by the decision tree-based algorithm, and calculates the variable importance of each feature.

(3) Subsequently, when a variable importance of the selection target feature calculated in (2) is greater than the variable importance of the fake feature, the feature selection unit 233 counts the variable importance.

(4) The feature selection unit 233 repeats the processing of (1) to (3) a plurality of times and selects the feature statistically determined to be significant as a feature effective for classification.

The learning unit 234 performs learning for a machine learning model (classification model) that classifies whether input Tweets are the Tweets of the reports of the phishing attacks through supervised learning using the features selected by the feature selection unit 233. For example, the learning unit 234 trains the classification model through the supervised learning using the features selected by the feature selection unit 233 on training data related to the phishing attacks (data to which a correct answer label indicating whether each Tweet is a phishing attack is given).

The classification unit 235 classifies whether the input Tweet is the Tweet of the report of the phishing attack using the classification model trained by the learning unit 234. The output processing unit 236 outputs a classification result of the Tweet by the classification unit 235.

[Example of Processing Procedure] Next, an example of a processing procedure of the classification device 20 will be described with reference to FIG. 8B. First, the data acquisition unit 231 of the classification device 20 acquires the Tweets that are highly likely to be the reports of the phishing attacks collected by the collection device 10 and the data of the Tweets (S11: acquisition of the collected data). Thereafter, the feature extraction unit 232 extracts features from the Tweets acquired by the data acquisition unit 231 and the data of the Tweets (S12: extraction of the features of the Tweets).

After S12, the feature selection unit 233 selects the features effective for classification of whether the Tweets are the Tweets related to the reports of the phishing attacks from the features extracted in S12 (S13). Then, the learning unit 234 trains the classification model that classifies whether the input Tweets are the Tweets of the reports of the phishing attacks using the features selected in S13 for the training data related to the phishing attacks (S14).

After S14, the classification unit 235 classifies whether the inputs Tweets are the Tweets of the reports of the phishing attacks using the classification model trained in S14 (S15).

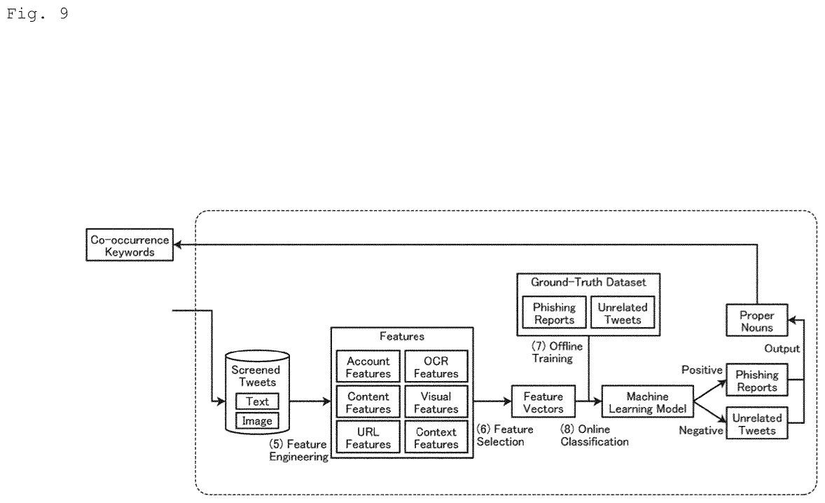

Then, the output processing unit 236 outputs the classification result in S16 (S16).

[Specific Example of Processing Procedure] Next, an example of a processing procedure of the classification device 20 will be described with reference to FIG. 9.

### (5) Feature Engineering

First, the data acquisition unit 231 of the classification device 20 acquires the Tweets collected by the collection device 10 (screened Tweets) and the data of the Tweets. The feature extraction unit 232 extracts the features from the Tweets acquired by the data acquisition unit 231 and the data of the Tweets.

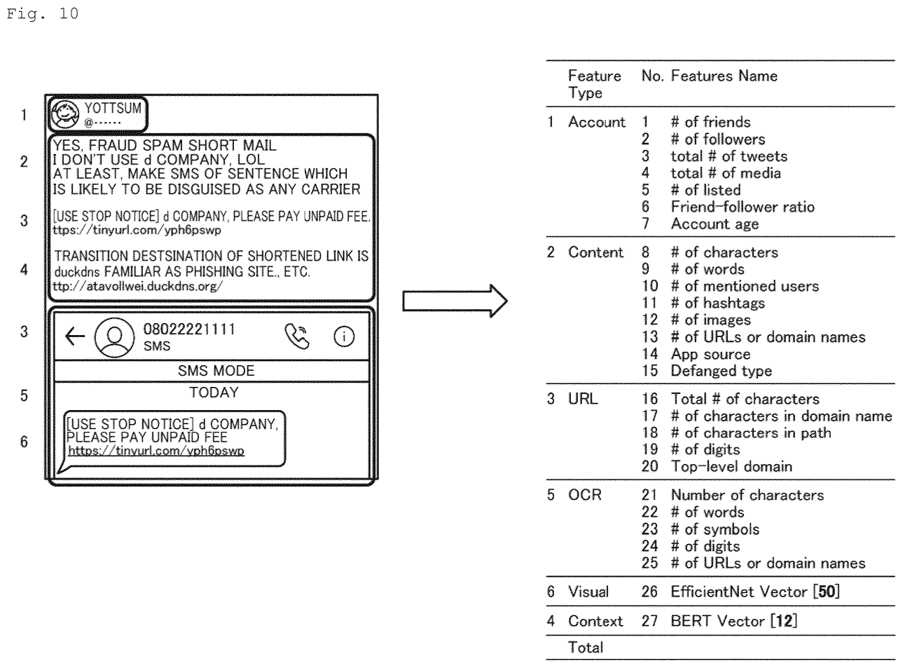

For example, as illustrated in FIG. 10, the feature extraction unit 232 extracts six types of features, account features (1) from the accounts of the Tweets, content features (2) from information associated with the Tweets, URL features (3) from extracted URLs, OCR features (5) from character strings extracted through OCR, visual features (6) from the outer appearances of the images, and context features (4) from contexts of the Tweets, that is, features of a total of 27 items. Hereinafter, the features will be described in detail.

### (5-1) Account Feature

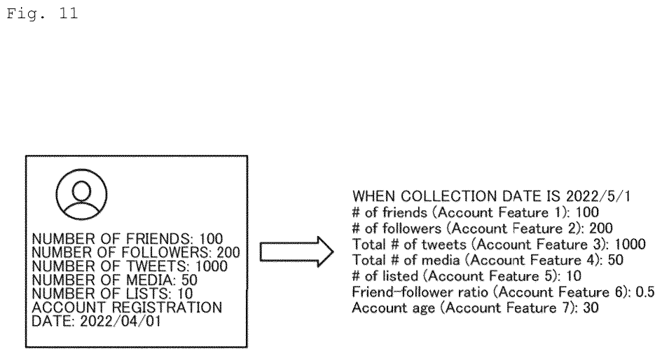

In order to ascertain features of the users of Twitter, the feature extraction unit 232 generates the account features for each Tweet from information regarding the accounts of the users (for example, the number of friends, the number of followers, the number of Tweets, the number of media, the number of lists, an account registration dates, and the like), for example, as illustrated in FIG. 11.

### (5-2) Content Feature

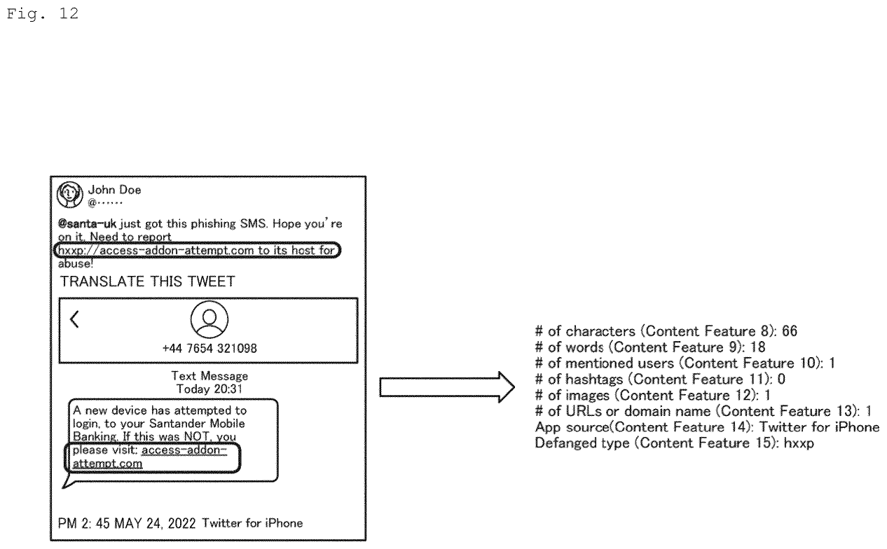

In order to ascertain features of the content frequently shown in the Tweets of the reports of the phishing attacks, the feature extraction unit 232 generates the content features for each Tweet from information associated with the Tweets themselves (for example, character strings, mentioned users, hash tags, images, URLs or domain names, applications used for the Tweets, defanged types, and the like), for example, as illustrated in FIG. 12.

### (5-3) URL Feature

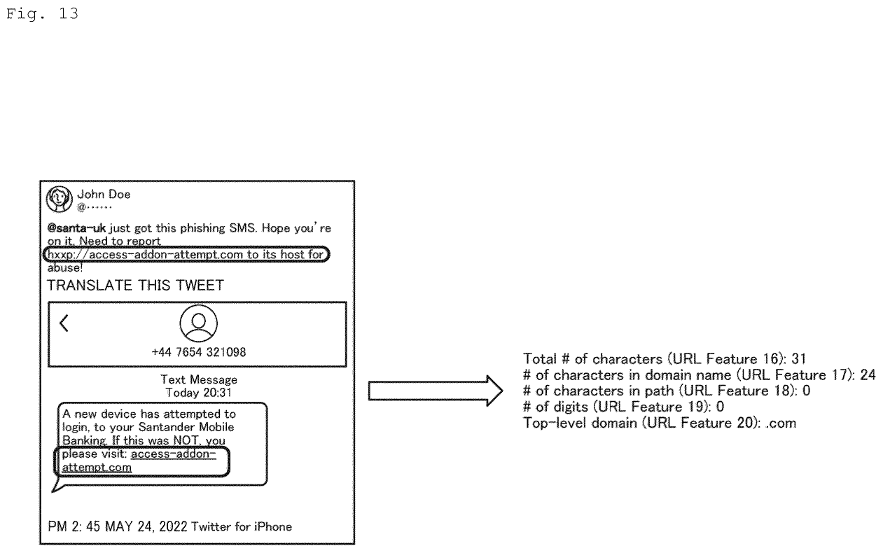

In order to ascertain features related to abuse of sub-domains specific to phishing URLs and abuse of specific top-level domains, the feature extraction unit 232 generates URL features for each Tweet from URLs (or domain names) extracted from both the character strings of the Tweets and images, for example, as illustrated in FIG. 13. The URL Features are, for example, character strings of the URLs, the domain names, paths, numbers included in the URLs, top level domains, and the like.

### (5-4) OCR Feature

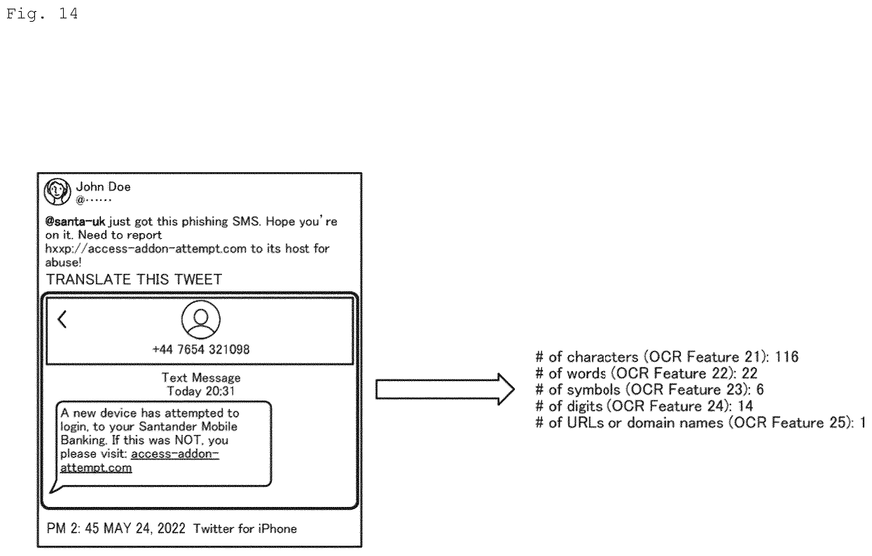

In order to ascertain features of similar character strings in the Tweets related to the phishing attacks, the feature extraction unit 232 generates OCR features for each Tweet from character strings extracted through optical character recognition (OCR), as illustrated in FIG. 14. The OCR features are, for example, character strings, words, symbols, numbers, URLs, domain names, and the like.

(5-5) Visual Feature In order to ascertain the commonality of the outer appearances of images included in the Tweet related to the report of the phishing attack, the feature extraction unit 232 generates visual features for each Tweet from images associated with the Tweets.

The feature extraction unit 232 generates vectors of fixed dimensions of images associated with the Tweets using an Efficient Net model (see Literature 5) which provides excellent results in image classification. Thereafter, the feature extraction unit 232 compresses the dimensions of the vectors by a truncated SV (see Literature 6) that converts sparse vectors into dense vectors. The feature extraction unit 232 sets the compressed vectors as visual features of the images included in the Tweets.
Literature 5: Tan, Mingxing and Le, Quoc., “EfficientNet: Rethinking Model Scaling for Convolutional Neural Networks”, ICML 2019.
Literature 6: “The truncatedsvd as a method for regularization”, BIT Numerical Mathematics.

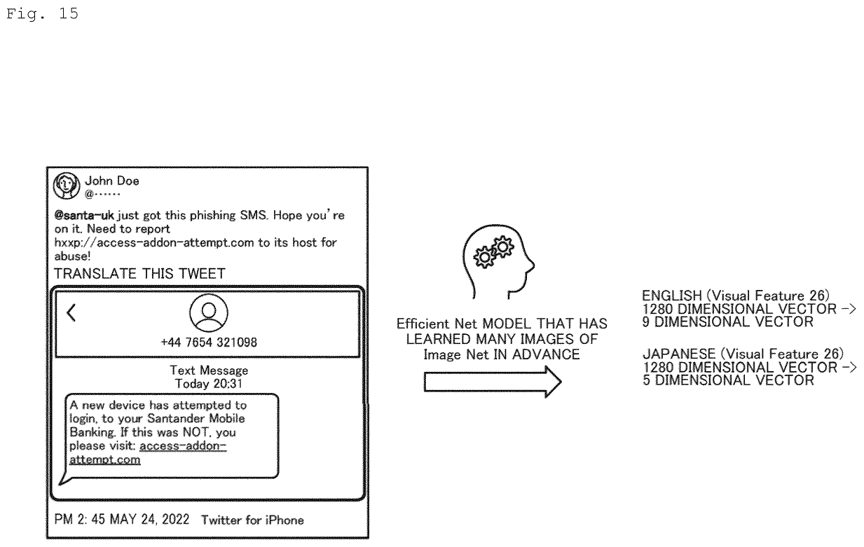

As illustrated in FIG. 15, for example, the feature extraction unit 232 converts the images associated with the Tweets into unique dimension vectors using an Efficient Net model that has learned many images of an Image Net in advance. Then, the feature extraction unit 232 compresses the converted vectors at a cumulative contribution rate of 99% in training data by the truncated SV.

### (5-6) Context Feature

In order to ascertain commonality of contexts in the Tweets related to the reports of the phishing attacks, the feature extraction unit 232 generates the context features for each Tweet from the character strings in the Tweets.

The feature extraction unit 232 generates vectors of fixed dimensions from character strings in the Tweets, for example, using a BERT model which shows an excellent result in sentence classification. Thereafter, the feature extraction unit 232 compresses the dimensions of the vectors by the truncated SV. Then, the feature extraction unit 232 sets the compressed vectors as context features of the Tweets.

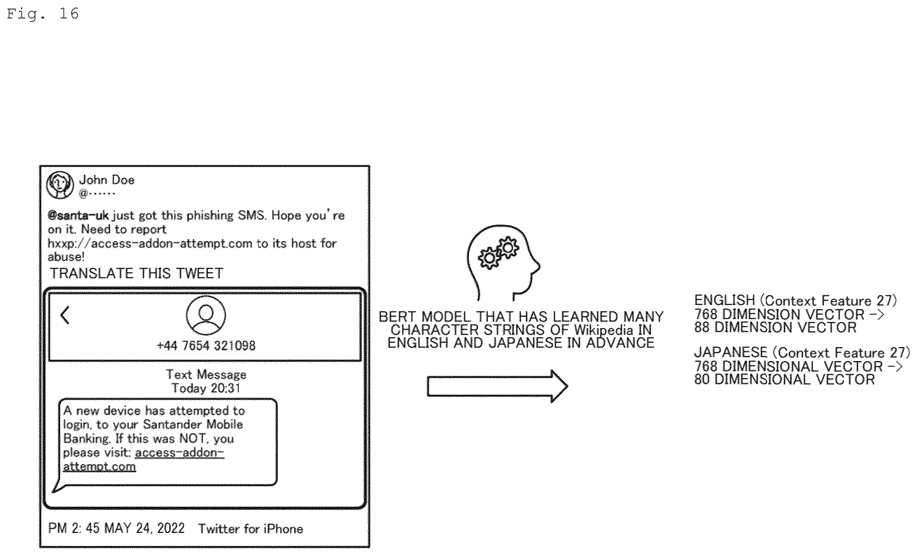

As illustrated in FIG. 16, for example, the feature extraction unit 232 converts the character strings in the Tweets into the vectors of unique dimension using a BERT model that has learned many character strings of Wikipedia in English and Japanese in advance. Then, the feature extraction unit 232 compresses the converted vectors to a cumulative contribution rate of 99% in the training data by the truncated SV.

### (6) Feature Selection

The feature selection unit 233 selects features (important) effective for classification of the Tweets of the reports of phishing attacks and other Tweets from a feature group generated by the feature extraction unit 232 in (5).

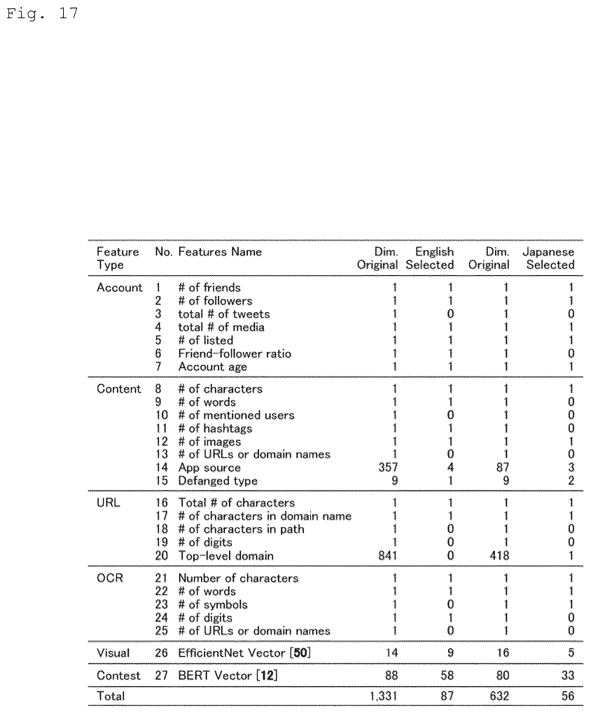

FIG. 17 illustrates an example of the features determined as important features in the classification as results of the feature selection.
Account Feature: six types in English (six dimensions), five types in Japanese (five dimensions)
Content Feature: six types in English (nine dimensions), four types in Japanese (seven dimensions)
URL Feature: two types in English (two dimensions), three types in Japanese (three dimensions)
OCR Feature: three types in English (three dimensions), three types in Japanese (three dimensions)
Visual Feature: nine dimensions in English, five dimensions in Japanese
Context Feature: fifty eight dimensions in English, thirty three dimensions in Japanese

In the context feature illustrated in FIG. 17, for App source (14), Twitter Web App, Twitter for iphone (registered trademark), and Twitter for Android (registered trademark) were important in both languages and PhishingPicker was important only in English. Also, for the defanged type (15), example[.]com was important in both languages and hxxp was important only in Japanese. Further, in the URL feature illustrated in FIG. 17, for the top-level domain (20), .xyz was important only in Japanese.

Finally, it was confirmed that the features of features of English 87 dimensions and Japanese 56 dimensions were important for the classification of the Tweets of the phishing attacks and other Tweets.

### (7) Offline Training

The learning unit 234 trains a classification model (machine learning model) using the features (feature vectors) selected by the feature selection unit 233 in (6) and training data (ground-truth dataset) to which a correct answer label indicating whether an attack is a phishing attack is given.

As an algorithm used in learning for the classification model, for example, Random Forest, Neural Network, Decision Tree, Support Vector Machine, Logistic Regression, Naive Bayes, Gradient Boosting, Stochastic Gradient Descent, or the like can be considered. For such an algorithm, as a result of evaluation of training data, it was confirmed that Random Forest is preferably used for the following three reasons.
Random Forest was more excellent than any other algorithms in classification accuracy.
Random Forest was operated at a stable speed in phases of both learning and estimation (classification).
In Random Forest, importances of features were distributed for all six types of features.

### (8) Online Classification

The classification unit 235 classifies whether the Tweets collected by the collection device 10 are Tweets (positive) related to the reports of the phishing attacks or Tweets (negative) unrelated to the reports of the phishing attacks using a machine learning model (classification model) trained in (7). The output processing unit 236 outputs a result of the classification.

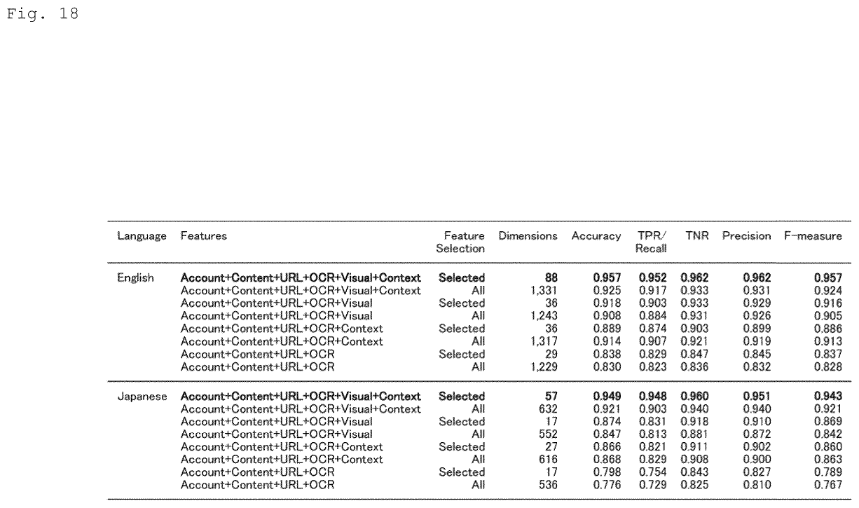

The classification device 20 may extract proper nouns shown in the Tweets classified as the reports of the phishing attacks, and the collection device 10 may use the proper nouns when the co-occurrence keywords are extracted.

[Evaluation Result] Next, an evaluation result of the system according to the embodiment will be described. For example, it was confirmed that the system can classify whether the Tweets are Tweets of the reports of the phishing attacks with accuracy of about 95% in both English and Japanese by using the features selected by the system (see FIG. 18).

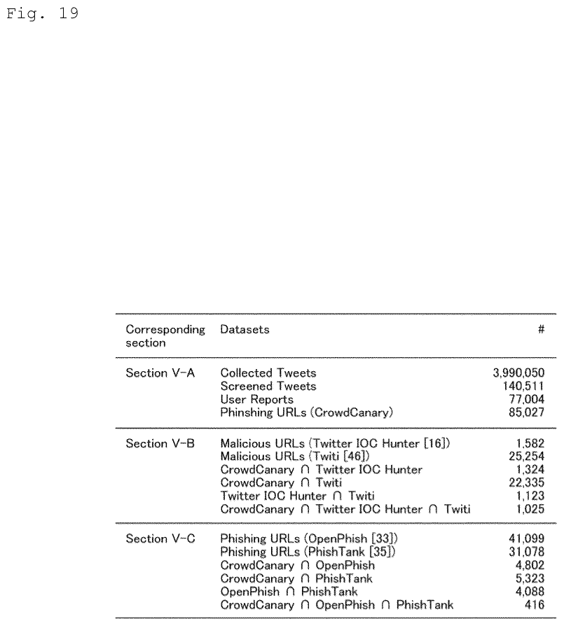

The system according to the embodiment could extract reports of 77,004 phishing attacks (user reports) and 85,027 phishing URLs (phishing URLs), as illustrated in FIG. 19, during an experimental period (2021 Aug. 1 to 2021 Sep. 30).

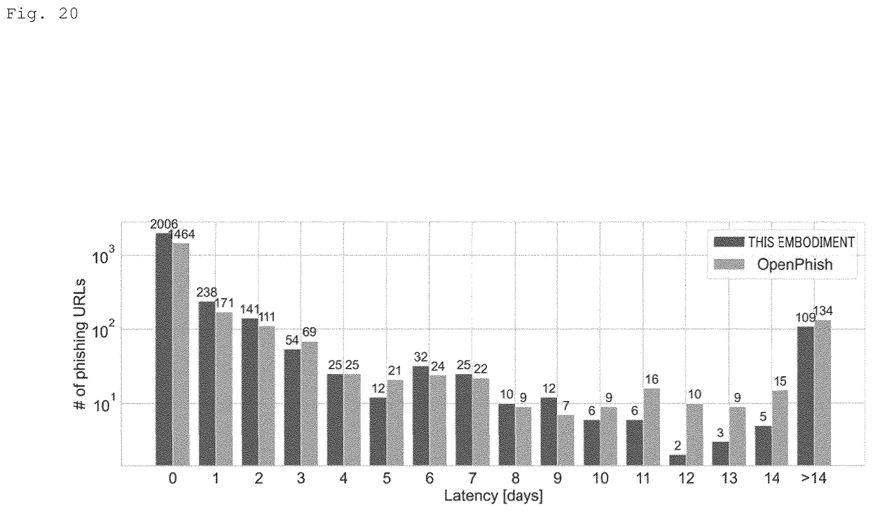

Further, when the phishing URLs collected by OpenPhish (see Literature 7) which is an existing data feed are compared with the phishing URLs collected by the system according to the embodiment (see FIG. 20), the system according to the embodiment could collect 2,686 (55.9% in total) phishing URLs earlier among 4,802 phishing URLs common to both the phishing URLS.
Literature 7: “OpenPhish-Phishing Intelligence”, https://openphish.com

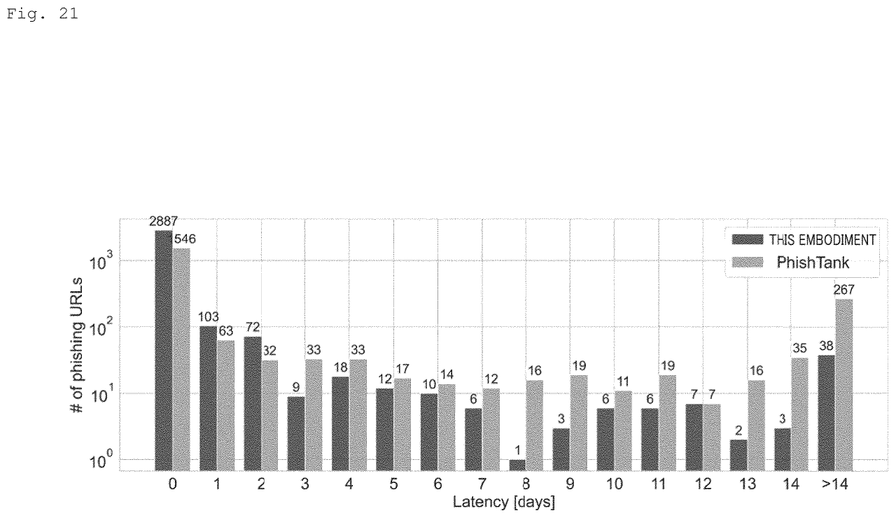

Further, when the phishing URLs collected by PhishTank (see Literature 8) which is an existing data feed are compared with the phishing URLs collected by the system according to the embodiment (see FIG. 21), the system according to the embodiment could collect 3,183 (59.8% in total) phishing URLs earlier among 5,323 phishing URLs common to both the phishing URLS.
Literature 8: “PhishTank|Join the fight against phishing”, https://www.phishtank.com/.

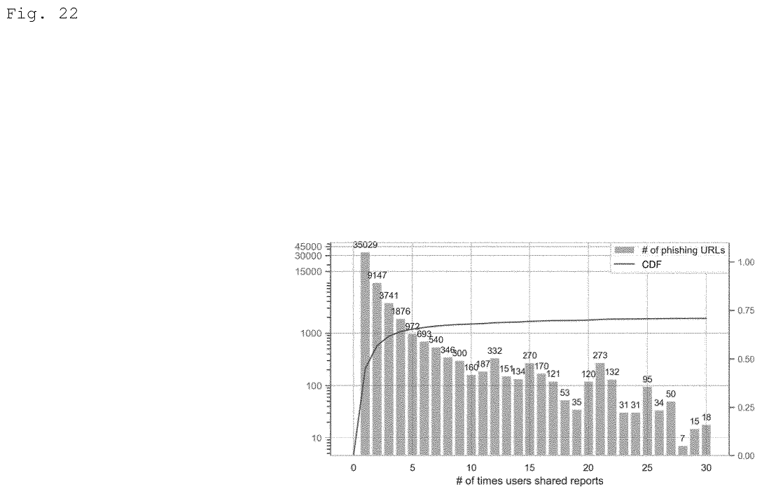

Further, the number of reports of the phishing attacks by users and the number of phishing URLs were investigated, and it was confirmed that phishing attacks only once reported by the users were 49.8% of the whole phishing URLs (see FIG. 22). That is, it was confirmed that the reports of the phishing attacks from a wide range of users were likely to include the phishing URLs with high uniqueness. From this, it was confirmed that it was very effective to collect the reports of the phishing attacks from the wide range of users as in the system according to the embodiment.

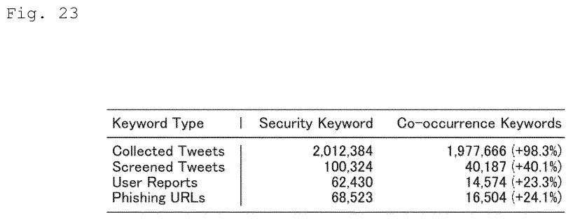

In the collection of the Tweets of the reports of the phishing attacks, it was confirmed that there is the effect that not only fixed keywords (security keywords) but also dynamic keywords (co-occurrence keywords) were used (see FIG. 23). As a result, it was confirmed that, when not only fixed keywords (security keywords) but also dynamic keywords (co-occurrence keywords) were used, the user reports (Tweets of the reports of the phishing attacks) could be extracted by +23.3% than when only the fixed keywords (security keywords) were used. It was confirmed that, when not only the fixed keywords (security Keywords) but also the dynamic keywords (co-occurrence keywords) were used, the phishing URLs could be extracted by +24.1%

From this, it was confirmed that, in the collection of the Tweets, it is considerably effective for the collection of the information regarding the phishing attacks using not only the fixed keywords (security Keywords) but also the dynamic keywords (co-occurrence keywords) as in the system according to the embodiment.

[System Configuration, etc.] Each constituent element of each of the illustrated units is functionally conceptual and is not necessarily physically configured as illustrated. That is, specific forms of distribution and integration of devices are not limited to those illustrated in the drawings and some or all of the devices may be functionally or physically distributed or integrated in any unit depending on various loads, usage conditions, or the like. Further, some or all of the processing functions performed in each device can be implemented by a CPU and a program executed by the CPU or can be implemented as hardware by a wired logic.

Of the steps of processing described in the foregoing embodiment, some or all of the steps of processing described as being automatically executed may also be manually executed. Alternatively, some or all of the steps of processing described as being manually executed may also be automatically executed using a known method. In addition, the processing procedure, the control procedure, specific names, information including various types of data and parameters that are illustrated in the foregoing literatures and drawings may be arbitrarily changed unless otherwise mentioned.

[Program] The foregoing system can be implemented by installing a program as package software or online software on a desired computer. For example, by causing an information processing device to execute the foregoing program, it is possible to cause the information processing device to function as the system. A category of the information processing device to be described here includes a mobile communication terminal such as a smartphone, a mobile phone, or a personal handyphone system (PHS), and a terminal such as a personal digital assistant (PDA).

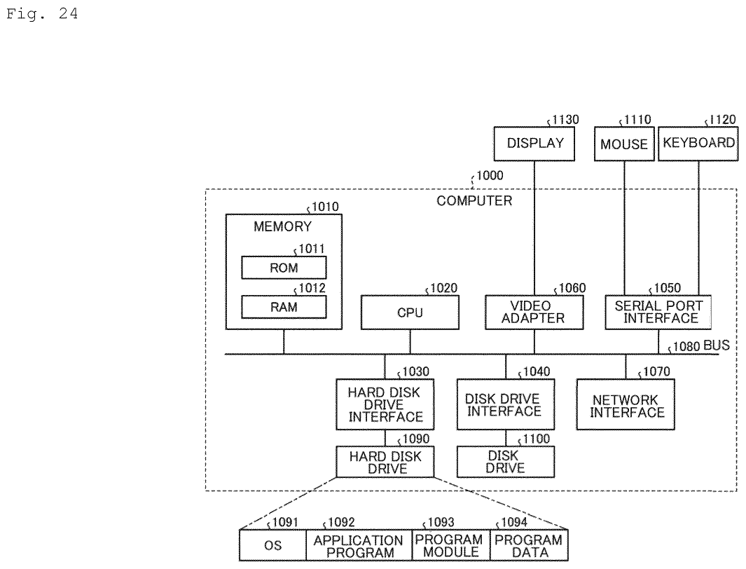

FIG. 24 is a diagram illustrating an example of a computer that executes a program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a detachable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each processing executed by the foregoing system is implemented as the program module 1093 in which a computer-executable code is described. The program module 1093 is stored in, for example, the hard disk drive 1090. For example, the program module 1093 that executes processing similar to the functional configuration in the system is stored in the hard disk drive 1090. The hard disk drive 1090 may be replaced with a solid state drive (SSD).

Data used in the processing of the above-described embodiment is stored as the program data 1094 in, for example, the memory 1010 or the hard disk drive 1090. The CPU 1020 reads the program module 1093 and the program data 1094 stored in the memory 1010 or the hard disk drive 1090 into the RAM 1012 and executes the program module 1093 and the program data 1094 as necessary.

The program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

### REFERENCE SIGNS LIST

10 Collection device
11.21 Input/output unit
12.22 Storage unit
13.23 Control unit
20 Classification device
131 First collection unit
132 Keyword extraction unit
133 Second collection unit
134 Data collection unit
135 URL/domain name extraction unit
136 Selection unit
231 Data acquisition unit
232 Feature extraction unit
233 Feature selection unit
234 Learning unit
235 Classification unit
236 Output processing unit

1. A collection device comprising:
a memory; and
processing circuitry configured to:
collect postings related to a security threat from postings of a social networking service (SNS) using a security keyword that is a keyword related to the security threat:
extract a co-occurrence keyword that is a keyword co-occurring beyond a predetermined frequency from the collected postings related to the security threat; and
collect a posting including the co-occurrence keyword and an image associated with the posting from the postings of the SNS.

2. The collection device according to claim 1,
wherein the processing circuitry is further configured to select a posting that is likely to be a posting related to the security threat from the postings based on a URL or a domain name extracted from text and an image of the posting collected and output the posting.

3. The collection device according to claim 2,
wherein the processing circuitry is further configured to select the posting as a posting that is likely to be the posting related to the security threat when the URL or the domain name extracted from the text and the image of the posting collected is not included in a list of URLs or domain names of legitimate websites or when a usage period of the domain name is less than a predetermined period.

4. The collection device according to claim 1,
wherein the processing circuitry is further configured to collect the posting for each predetermined period, and
extract the co-occurrence keyword from the postings collected for the predetermined period.

5. A collection method performed by a collection device, the collection method comprising:
collecting postings related to a security threat from postings of a social networking service (SNS) using a security keyword that is a keyword related to the security threat;
extracting a co-occurrence keyword that is a keyword co-occurring beyond a predetermined frequency from the collected postings related to the security threat; and
collecting a text of a posting including the co-occurrence keyword and an image associated with the posting from the postings of the SNS.

6. A non-transitory computer-readable recording medium storing therein a collection program that causes a computer to execute a process comprising:
collecting postings related to a security threat from postings of a social networking service (SNS) using a security keyword that is a keyword related to the security threat;
extracting a co-occurrence keyword that is a keyword co-occurring beyond a predetermined frequency from the collected postings related to the security threat; and
collecting a posting including the co-occurrence keyword and an image associated with the posting from the postings of the SNS.
